(19) United States
(12) Patent Application Publication
(10) Pub. No.: US 2009/0075007 A1
(43) Pub. Date: Mar. 19, 2009

(54) ADHESIVE COMPOSITE

(75) Inventors: Jonathan P. Kitchin, Austin, TX (US); Manisha Sarkar, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/854,619

(22) Filed: Sep. 13, 2007

(51) Int. Cl. B32B 27/08

(52) U.S. Cl. 428/41.3; 428/41.8

(57) ABSTRACT

An adhesive composite is provided. The adhesive composite includes a support layer sandwiched between a repositionable adhesive and a permanent adhesive. The support layer has a stiffness of less than about 50,000 Newton per meter in its cross-web direction, as measured according to ASTM 882-02. The repositionable adhesive has an adhesion to polyester greater than about 200 gram per inch.

### CROSS REFERENCE TO RELATED APPLICATION

This application is related to an application having an attorney docket number 62594US003, which claims priority to U.S. Provisional application 60/829,024 filed on Oct. 11, 2006, entitled Repositionable Adhesive-Backed Photographs and Photo Media and Method of Making, application 63604US002, entitled Photographic Print with Adhesive Composite, and application 63605US002, entitled Method of Making a Photographic Print with Adhesive Composite, all applications being filed on even date herewith.

### BACKGROUND

With the popularity of digital cameras and the availability of desktop printers, many consumers today have the flexibility of previewing digital photos and printing only the ones they desire in their home. While home printing has become more common practice, commercial printing of the consumers' digital pictures continues to be an option for those consumers who prefer to send their digital photos to a photo processor.

Commercial printing takes two general forms. First, in-store digital mini photo labs allow consumers to select their own pictures for processing when they insert a memory card from the camera into a touch screen kiosk. Instructions on the kiosk appear and walk the consumer through the process. This first type of commercial printing can be referred to as “retail” photo processing. Second, wholesale photo processing labs provide mail order fulfillment of requests for digital prints. Typically, consumers submit their requests for photographic prints to photo hosting websites on the Internet. This second type of commercial printing can be referred to as “wholesale” photo processing.

Both retail and wholesale photo processing operations can produce digital prints on conventional photosensitive silver halide photo paper. The process typically requires image wise scanning with red, green, and blue light followed by wet chemical processing to produce an image. The wet chemical processing typically involves developing, bleaching and fixing, washing and stabilizing, and finally drying of the resulting silver halide photo paper. Black and white as well as color photographic prints can be produced using this process. Conventional silver halide photo processing continues to be common practice because it uses entrenched technology and because of the relatively low cost and high quality prints that result from it.

Some skilled in the art have devised a process of applying an adhesive, which is typically protected by a liner, to photo paper prior to the wet chemical processing steps. In such a case, the adhesive and the liner need to withstand, not to interfere, and not to contaminate the chemicals used in the process. Exemplary references directed to this method and articles made therefrom includes CH 568857; U.S. Pat. No. 6,045,965 (Cournoyer et al.); U.S. Pat. No. 6,514,646 (Nair et al.); and U.S. Pat. No. 6,645,690 (Nair et al.).

Instead of developing an adhesive system that can withstand the wet chemical processing, a photo processor, however, can use alternate techniques to make adhesive-backed silver halide photographic prints after the wet chemical processing. The photo processor can use, for example, commercially available adhesive transfer tapes. An adhesive transfer tape typically consists of an adhesive coated on a release liner. The adhesive may be a repositionable pressure sensitive adhesive (PSA). Such adhesive transfer tapes can be applied to a backside (i.e., the non-imaged side) of a silver halide photograph. The liner stays in place until the consumer wants to display the photographic print, upon which time she or he will peel back and discard the liner to expose the adhesive and then attach the photographic print to a desired display surface. In practice, however, adhesive transfer tapes, especially repositionable PSA transfer tapes, do not work well on the backside of silver halide photographs because the backside has a layer of polyethylene. The transfer adhesive adheres poorly to the transfer adhesive. Upon removal of the photograph print from an intended display surface, such as varnished wood, a painted wall, or glass, the transfer adhesive could transfer to the display surface, a highly undesirable effect. To increase the anchorage between the transfer adhesive and the backside of the silver halide print, a prime coat can be between the two layers. Such a coating would add an extra step in the process that may be time consuming and may not be cost effective.

Some skilled in the art have described articles containing a PSA, whether repositionable or not, and methods of making them. Illustrative references include Patent Disclosure DE 2515330; U.S. Pat. No. 4,201,613 (Olivieri et al.), U.S. Pat. No. 4,285,999 (Olivieri et al.), U.S. Pat. No. 4,507,166 (Posner), U.S. Pat. No. 6,403,185 (Neuburger et al.), and U.S. Pat. No. 7,087,280 (Neuburger); US Patent Application Publications US 2004/0137183 and US 2006/0057326, and PCT Publication WO 1999/012466.

Silver halide photographic prints have a tendency to curl in environments with high humidity (e.g., greater than about 75% relative humidity) or low humidity (e.g., less than about 25% relative humidity). Typically, the edges or corners of the photograph will curl such that it will no longer lie planar to a display surface. With extended exposure to the high or low humidity conditions, the photographic print may curl through a ninety degree angle or more. Thus, any adhesive system used with the photographic prints should not exasperate but instead should help alleviate the curl they may experience.

### SUMMARY

The present invention solves many of the problems discussed above in that the invention provides for a way to create an adhesive backed conventional silver halide photograph prints after the wet chemical processing steps. Advantageously, the invention provides a cost efficient attachment system to the photograph prints that minimizes curling that the prints may experience.

In one aspect, the invention pertains to an adhesive composite comprising (a) a repositionable adhesive; (b) a support layer disposed on the repositionable adhesive, the support layer having a stiffness of less than about 50,000 Newton per meter in the support layer's cross-web direction, as measured according to ASTM 882-02; and (c) a permanent pressure sensitive adhesive disposed on the support layer, wherein the repositionable adhesive has an adhesion to polyester of greater than about 200 gram per inch. In another embodiment, the adhesive composite further comprises a differential release liner having opposing first and second surfaces. The first surface of the liner is in contact with the repositionable adhesive.

In another aspect, the invention pertains to a photographic print comprising (a) a differential release liner having opposing first and second surfaces, the first surface having a higher release value compared to the second surface; (b) an adhesive composite comprising (i) a repositionable adhesive disposed on the first side of the liner; (ii) a support layer disposed on the repositionable adhesive, the support layer having a stiffness of less than about 50,000 Newton per meter in the support layer's cross-web direction, as measured according to ASTM 882-02; and (iii) a permanent pressure sensitive adhesive disposed on the support layer; and (b) a photograph print having opposing first and second surfaces, the first surface containing an image and the second surface disposed on the permanent adhesive.

In yet another aspect, the invention pertains to a method for making a photographic printing having an adhesive comprising the steps of (a) providing a roll of dual coated adhesive tape comprising (i) a differential release liner having opposing first and second surfaces, the first surface having a higher release value than the second surface; (ii) a repositionable adhesive disposed on the first side of the liner; (iii) a support layer disposed on the repositionable adhesive, the support layer having a stiffness of less than about 50,000 Newton per meter in its cross-web direction, as measured according to ASTM 882-02; and (iv) a permanent pressure sensitive adhesive disposed on the support layer; (b) providing a roll of photographic print having two substantially parallel edges having opposing first and second surfaces, the first surface containing an image; and (c) laminating the tape and the photographic print such that the permanent adhesive of the tape contacts the second surface of the print.

As used herein, the term “photographic print” generally means an imaged photo paper having opposing first and second surfaces, the first surface containing the image that the consumer wanted to capture with his or her camera (digital or conventional camera) and second surface typically containing a coating of polymeric material, such as polyethylene. The term “photo paper” generally means media having an image receptive first surface that one (such as photo processors or consumers) uses as input or raw materials to produce photographic prints.

Once done with displaying the photographic print, the consumer can archive it, if desired. In this way, photograph prints can be updated on a regular basis and they can be displayed quickly without the need to use frames or alternative hardware. Photograph prints can also be displayed on any horizontal or vertical surface that the repositionable adhesive can be adhered, such as, e.g., refrigerators (without the need for using magnets), wood or plastic surfaces (without the need for using additional tape), fabrics, walls, and windows. The repositionable adhesive used in the present invention provides good adhesion to the intended surface and yet will not leave residue adhesive once the photograph has been removed.

In this document, the term “about” is presumed to modify all numeric values.

### BRIEF DESCRIPTION OF THE DRAWINGS

The present invention can be better explained with reference to the drawings, wherein:

FIG. 1 is a cross-sectional view of an illustrative adhesive composite;

FIG. 2 is a cross-sectional view of an illustrative photographic print using an adhesive composite;

FIG. 3 is a schematic view of an illustrative method of making a photographic print with an adhesive composite; and

FIG. 4 is a top plan view of an illustrative section of a photographic print to the adhesive composite made from the method of FIG. 3.

The drawings present the invention by way of representations and not limitation. Numerous other modifications and embodiments can be devised by one skilled in the art which fall within the scope and spirit of the principals of this invention. The figures are idealized, are not drawn to scale, and are intended merely for illustrative purposes.

### DETAILED DESCRIPTION

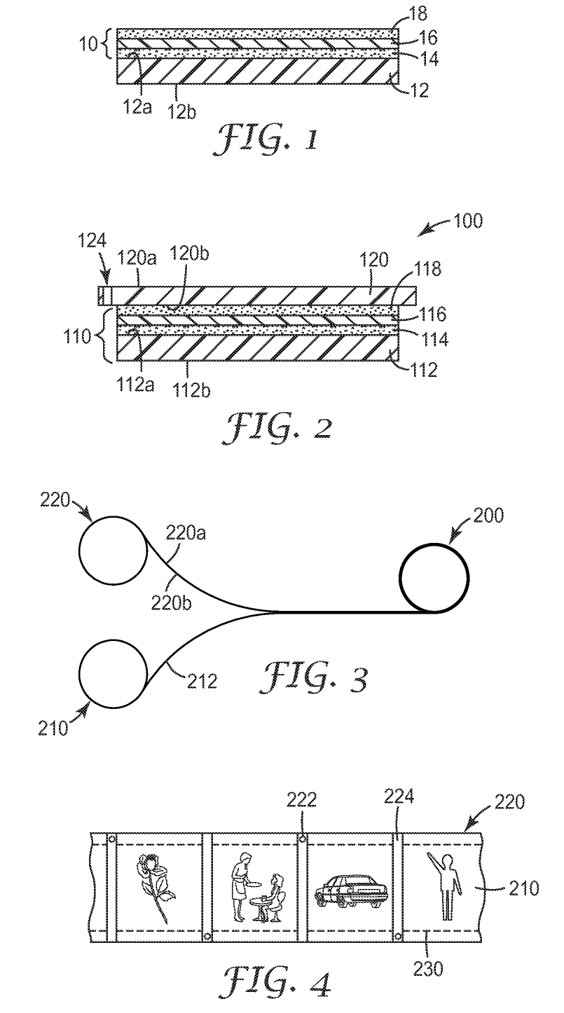

FIG. 1 depicts a cross sectional view of an exemplary adhesive composite 10 having a three layer construction with a support layer 16 sandwiched between a repositionable adhesive 14 and a permanent adhesive 18. The three layers are substantially coextensive with one another. In one application, the adhesive composite 10 is disposed on a liner 12 to form a sheet of adhesive composite. The liner has opposing first and second sides 12a and 12b respectively. In another application, the liner is a differential release liner, meaning that the first side has a different release value than the second side. The first side of the liner, upon which the repositionable adhesive lies, is the tight side, and the second side is the easy side. That is to say, the release on the first side is higher than the second side. In an embodiment with the differential release, the product can readily be packaged in a roll form to yield a roll of tape.

FIG. 2 depicts a cross sectional view of an exemplary adhesive backed photographic print 100 having an adhesive composite 110 sandwiched between a photographic print 120 and a liner 112. The print 120 has opposing first and second surfaces, 120a and 120b respectively, with the first surface containing an image that a consumer had captured using his/her digital, video, or conventional camera. The print optionally includes a hole 124 disposed near an edge but not covered by the adhesive composite 110. The liner has opposing first and second surfaces, 112a and 112b respectively. The adhesive composite includes a support layer 116 sandwiched between a repositionable adhesive 114 and a permanent adhesive 118. The repositionable adhesive of the composite is disposed on the first surface 112a of the liner while the permanent adhesive of the composite is disposed on the second surface 120b of the print 120. In one application, the adhesive composite 110 and liner 112 are narrower than the print 120 thus leaving at least one edge of the print free of the adhesive composite. The narrower width adhesive composite and liner allows for easy liner removal prior to use, as well as easy removal of the print from a display surface.

FIG. 3 depicts a schematic view of an exemplary process of making a photographic print with an adhesive composite. The process can be generally described as semi-continuous a roll-to-roll process. A first input roll 220 is a roll of photographic prints having opposing first and second surfaces, with the first surface containing a plurality of images disposed down web. A second input roll 210 is an adhesive composite tape similar in construction to the embodiment shown in FIG. 1 in roll form. The adhesive composite is disposed on a differential release liner 212 with a repositionable adhesive in contact with a first surface of the liner. The first and second input rolls unwind such that a web of the photographic print (i.e., first input roll) has its second face proximate to the permanent adhesive of the adhesive composite (i.e., second input roll). In one embodiment, the first roll includes a plurality of registration marks along the web's length between any two adjacent images. The registration marks can be, e.g., in the form of printed marks or holes disposed adjacent to at least one of two edges of the web. In one method, the holes are formed by punching out a small circle near the edge of the photographic print.

The two webs are laminated such that the permanent adhesive comes into direct contact with the second surface of the photographic print. In one method the laminated webs are wound up as output roll 200, which is the photographic print laminated with the adhesive composite. In another method, the laminated web passes by a reader capable of detecting the registration mark on the photographic print. The laminated web can then be cut along or near the registration mark to yield individual laminated photographic prints, i.e., one image per print.

While FIG. 3 shows a semi-continuous roll-to-roll process, the present invention can be practiced by laminating sheets of adhesive composites with photographic prints. In such a method, because the adhesive composite includes a permanent adhesive, care should be taken to align the adhesive composite with the print. Commercially available lamination equipment available can facilitate the alignment of the adhesive composite with the print and their lamination.

FIG. 4 depicts a top plan view of a portion of a plurality of laminated photographic prints with registration marks, in the form of holes 222, set in from the edges of the web. The holes alternate between the two edges and they lie between any two adjacent images. In some embodiments, any two images are segregated by a non-imaged, typically white, region 224 lying cross web. Phantom lines 230 demarcate the adhesive composite 210 on the second surface of the photographic print 220. Thus, the adhesive composite is narrower than the photographic print such that the adhesive composite does not cover the holes.

Turning now to the photo paper (and photograph prints made therefrom), it has opposing first and second surfaces. A silver halide photo paper typically contains a cellulose fiber paper support that has a polyolefin resin extrusion laminated on at least one major surface of the paper and more commonly on both major surfaces. A common polyolefin material used in the industry is polyethylene. The coated paper then goes through a series of processing steps where various chemicals are coated to a first major surface of the paper resulting in an image receptive side, to form the photosensitive silver halide chemistry. U.S. Pat. No. 6,045,965 (Cournoyer et al.) describes the various coatings and chemistries used to produce photosensitive silver halide paper. Manufacturers such as Eastman Kodak Company and Fuji Photo Film Company are well known suppliers silver halide photo paper. A second major surface of the paper (opposing the first major surface) is the backside. On the backside, over the polyolefin coating, there may be additional coatings that modify the surface properties of the polyolefin (such as, e.g., its coefficient of friction or its electrical resistivity). In the United States, standard size for the photographic print includes 3 by 5 inch, 4 by 6 inch, 5 by 7 inch, 8 by 10 inch. Photographic prints larger than 8 by 10 inch are typically considered posters. The present invention is operable with any size of the print and any poster size. Photographic prints typically include information printed on its second side. Illustrative types of printed information include, but not limited to, a customer number, a print processing date, and a logo of the photo paper's manufacturer. The adhesive composite of the present invention is sufficiently transparent so as not to obscure the printed information. In one embodiment, the adhesive composite has opacity of less than 25%. Opacity is defined as 100×R_{b}÷R_{w}, where R_{b} denotes the diffuse reflectance of the adhesive composite when laminated to a black surface and R_{w} denotes the diffuse reflectance of the adhesive composite when laminated to a white surface.

Turning now to the details of the adhesive composite, each of its components is discussed in below in detail.

When using the laminated photographic film, it is the repositionable adhesive comes into contact with the display surface. Common display surfaces include, but are not limited to, walls of houses or cubicles, refrigerator doors, windows, and metal surfaces. Types of display surfaces can include, but are not limited to, smooth varnished wood, painted metal, cardboard, smooth vinyl wallpaper, semi-gloss painted dry wall, and flat painted drywall. Any repositionable adhesive composition can be used, so long as it has an adhesion to polyester of about of about 200 gram per inch or greater. This minimum adhesion level provides better adhesion of the photographic print to the intended display surface. In one embodiment, the repositionable adhesive has an adhesion to polyester of about 300 gram per inch or less. This maximum adhesion value allows the laminated photographic print to be removed from the display surface without causing excessive curl. Thus, if desired, the photographic print can be displayed again on a different surface. In one exemplary embodiment, the repositionable adhesive is a polyacrylate based microsphere, as described in U.S. Pat. No. 5,824,748 (Kesti et al.). Other repositionable adhesives include those disclosed in the following US patents, U.S. Pat. No. 3,691,140 (Silver); U.S. Pat. No. 3,857,731 (Merrill et al.); U.S. Pat. No. 4,166,152 (Baker et al.); U.S. Pat. No. 4,495,318 (Howard); U.S. Pat. No. 5,045,569 (Delgado); U.S. Pat. No. 5,073,457 (Blackwell); U.S. Pat. No. 5,571,617 (Cooprider et al.), U.S. Pat. No. 5,663,241 (Takamatsu et al.); U.S. Pat. No. 5,714,327 (Cooprider et al.); U.S. RE 37563 (Cooprider et al.); U.S. Pat. No. 5,756,625 (Crandall et al.); and U.S. Pat. No. 5,877,252 (Tsujimoto et al.). The repositionable adhesive can be water based, solvent based, or a solventless hotmelt adhesive.

The adhesion of the repositionable adhesive to polyester can be characterized by the following test method. The test is performed by laminating a 1.25 inch (32 mm) strip of plain polyester, product designation OR16 film from 3M Company, St. Paul, Minn., over the previously coated and dried sample of repositionable adhesive. The polyester is laminated to the adhesive by using a 2 kg rubber coated roller rolling at a rate of 12 inch/min (25.4 mm/min). Using a stress/strain gauge, such as one available from Instron Corp., the polyester film is pulled away from the adhesive at a 90° angle at a peel rate of 12 inch/min (305 mm/min). The peel force is recorded in grams/inch width of the sample.

As stated above, photographic prints exposed to high or low humidity conditions will expand and contract. In order for the adhesive composite to accommodate the expansion and contraction the photographic print experiences, the adhesive composite needs to be to sufficiently elastic. It should be noted that the concept of elasticity and stiffness are related. A highly elastic material will have a low stiffness and vice versa.

The inventors have discovered that support layer of the adhesive composite can be chosen to accommodate the expansion and contraction of the photographic print. The support material should be able to stretch and contract, i.e., should be sufficiently elastic, without applying sufficient lateral force to the photographic print to cause substantial curling. Curling is substantial if it causes debonding or lifting of the repositionable adhesive from the display surface of more than about 3 mm after conditioned for seven days at about 23° C. and 20% relative humidity. Curl can be measured by the height of the highest region, typically a corner, of the photographic print when laid on a flat surface.

The elastic properties, and thus the stiffness, of the support layer are determined by the combination of its thickness and its Young's modulus. Suitable support layers have a Young's modulus of about 0.5 giga-Pascal (GPa) or less. In one embodiment, the support layer has a Young's modulus of about 0.1 GPa or less. In contrast, the printed literature and text books list a Young's modulus of 2.5 to 7 GPa for bond paper, such as paper used in photo copying machines. The present invention is inoperable when bond paper is used as the support layer of the adhesive composite. The thickness of the support layer is less than about 200 micrometer and preferably less than about 100 micrometer to minimize the overall thickness of the adhesive composite.

The combination of the support layer's thickness and its Young's modulus should be such that the stiffness of the support layer is less than about 50,000 Newton per meter in its cross-web direction, as measured according to ASTM 882-02, Standard Test Method for Tensile Properties of Thin Plastic Sheeting. In another embodiment, the support layer has a stiffness of less than about 20,000 Newton per meter in its cross-web direction, as measured according to ASTM 882-02. In brief summary, the test involves cutting a cross-web sample strip from a web of support layer. The strip measures about 25 mm wide and 305 mm long. The initial separation distance of the jaws is about 254 mm. The ends of the strip are inserted into the jaws of an Instron Model 4464 stress-strain machine. The Instron machine pulls the strip apart (i.e., the jaw distance widens from its initial separation distance) at a rate of about 25.4 mm per minute. A graph of the load (in Newtons) versus the extension (in meters) of the sample strip is then plotted to generate a curve. A change in strain (Δ Strain) between two points on a linear portion of the curve is calculated as the change in separation of the jaw distance divided by the initial jaw separation distance. The change in load (Δ Load) between the same two points on the linear portion of the curve is recorded. The stiffness of the sample can then be calculated according to the following equation: Stiffness=(Δ Load÷W)÷(Δ Strain), where W represents the width of the sample over which the load is applied.

Suitable support layers include tissue paper, natural polymer film, synthetic polymer film, woven fabric, and non-woven fabric. It should be noted that the stiffness of the support layers can differ in the down web and cross web directions. Dimensional changes of a photographic print, however, at high and low relative humidity conditions tend to be greater in the cross web direction than the down web direction. Thus, it is the cross web stiffness of the support layer that is measured.

The third component of the adhesive composite is the permanent adhesive, which is disposed on the support layer. Any permanent adhesive can be used, so long as it has good adhesion to the second side of the photographic print and the support layer. In one embodiment, the permanent adhesive is a polyacrylate.

One illustrative method of making the adhesive composite includes the following steps. A permanent adhesive is coated using any conventional coating techniques onto an easy release side of differential release liner. An illustrative differential release liner is a 0.0052 inch differential release polyethylene coated paper. An illustrative permanent adhesive is a solvent based acrylic adhesive. The solvent-based permanent adhesive is dried using, e.g., an oven. The support layer, such as any one of those described in Examples 1 to 4 below, is laminated to the permanent adhesive. A repositionable adhesive is coated onto the support layer using any conventional coating techniques. An illustrative repositionable adhesive is a water-based microsphere adhesive as described in U.S. Pat. No. 5,824,748 (Kesti et al.). Once dried, repositionable adhesive has a minimum adhesion to polyester of 200 grams per inch and should have a maximum adhesion to polyester of 300 gram per inch. The adhesive composite is wound up on the differential release liner to form a roll of tape. The tape roll can then be unwind, in which case, the microsphere-based repositionable adhesive transfers to the high release side of the differential release liner leaving the permanent adhesive exposed.

The liner covers, protects, bonds securely to, and yet releases cleanly and easily from the repositionable adhesive. The liner can be any paper or plastic sheet. In one embodiment, the liner is a differential release liner. The liner may be treated with a release coating to achieve the desired release performance. The release coating would be disposed on the second surface of the liner such that it would be disposed on the permanent adhesive. Suitable coatings include those that are based on straight chain alkane derivatives, polydialkyl siloxane derivatives, or fluorocarbon derivatives. One exemplary release coating is described in U.S. Pat. No. 5,032,460 (Kanter et al.). The release coating will be applied on the liner, typically the entire surface area of the liner, to reach a dry coating weight of from 0.05 to 0.1 g/ft² (0.54 to 1.1 g/m²). Suitable silicone-based release liners are commercially available from Loparex, Inc., Willowbrook, Ill.

### EXAMPLES

The stiffness of various support layers were measured according to ASTM 882-02. The results are tabulated in Table 1. All the samples had a width of 0.025 meters except for Comparative Example A, wherein a narrower sample width of 0.005 m was used to keep the load measurements for all examples on the same scale.

The support layer of Example 1 was a semi-crepe white tissue paper having a basis weight of about 13 grams per square meter having an average caliper of 38 micrometers and a Gurley porosity 22 by TAPPI test method 460. The paper was supplied from Burrows Paper Corporation, Little Falls, New York and with an Internet website address of www.burrowspaper.com.

The support layer of Example 2 was a Grade 85, 22 pound towel tissue paper supplied from SCA Tissues North America (Svenska Cellulosa Aktiebolaget, translating to Swedish Cellulose Incorporated), Neenah, Wisconsin and with an Internet website address of www.scatissue.com.

The support layer of Example 3 was a spunbound polypropylene non-woven fabric having a basis weight of 34 grams per square meter. The non-woven fabric was supplied from Polymer Group, Inc., Charlotte, N.C. and with an Internet website of www.polymergroupinc.com.

The support layer of Example 4 was a spunbond, meltblown, spunbond composite polypropylene non-woven fabric having a basis weight of 22 grams per square meter. The non-woven fabric was supplied from First Quality Nonwovens, Inc., Great Neck, New York and with an Internet website address of www.fqnonwovens.com.

The support layer of Comparative Example A was bond paper having a basis weight of 80 grams per square meter and an average thickness of 100 micrometer. The bond paper was supplied from Boise Cascade, LLC, Boise, Id. and with an Internet website address of www.bc.com.

TABLE 1

| | Δ Strain | Δ Load (N) | Stiffness (N/m) |
|---|---|---|---|
| Example 1 | 0.0047 | 1.85 | 15,440 |
| Example 2 | 0.0040 | 3.63 | 35,507 |
| Example 3 | 0.0232 | 2.91 | 4,935 |
| Example 4 | 0.0312 | 1.85 | 2,339 |
| Comparative A | 0.0031 | 3.85 | 243,970 |

As the data in Table 1 shows, support layers of Examples 1 to 4, all had a stiffness value of less than 50,000 Newton per meter. Comparative Example A, however, had a stiffness value well in excess of 50,000 Newton per meter and thus would be too stiff (i.e., not elastic enough) to function as a support layer in the adhesive composite. In fact, a photographic print having adhesive composite incorporating the support layer of Comparative Example A curled through an angle of about 100 degrees after being conditioned in a low humidity, i.e., at 20% relative humidity, at 23° C. for four weeks.

Although specific embodiments of the present invention have been shown and described, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. An adhesive composite comprising:
a repositionable adhesive;
a support layer disposed on the repositionable adhesive, the support layer having a stiffness of less than about 50,000 Newton per meter in its cross-web direction, as measured according to ASTM 882-02; and
a permanent pressure sensitive adhesive disposed on the support layer,
wherein the repositionable adhesive has an adhesion to polyester greater than about 200 gram per inch.

2. The adhesive composite of claim 1 further comprising a differential release liner having opposing first and second surfaces, the first surface disposed on the repositionable adhesive.

3. The adhesive composite of claim 2, wherein the first surface of the differential release liner has a higher release value compared to the second surface.

4. The adhesive composite of claim 1, wherein the support layer has a stiffness of less than about 20,000 Newton per meter in the support layer's cross-web direction, as measured according to ASTM 882-02.

5. The adhesive composite of claim 1, wherein the composite adhesive has opacity of less than about 25%.

6. The adhesive composite of claim 1, wherein the repositionable adhesive has an adhesion to polyester of less than about 300 gram per inch.

7. The adhesive composite of claim 1, wherein the support layer is selected from the group consisting of tissue paper, natural polymer film, synthetic polymer film, woven fabric, and non-woven fabric.

8. The adhesive composite of claim 7 wherein the non-woven fabric is selected from the group consisting of a spunbond fabric and a spunbond-meltblown fabric.

9. The adhesive composite of claim 8, wherein at least one of the spunbond fabric and spunbond-meltblown fabric is selected from the group consisting of polyethylene terephthate, polypropylene, polyethylene, polyethylene terephthate-cellulose acetate blend, and combinations thereof.

10. The adhesive composite of claim 1, wherein the support layer has a thickness of less than about 200 micrometer.

11. The adhesive composite of claim 1, wherein the support layer has a thickness of less than about 100 micrometer.

12. The adhesive composite of claim 1, wherein the support layer has a Young's modulus of about 0.5 GPa or less.

13. The adhesive composite of claim 1, wherein the support layer has a basis weight of less about 0.1 GPa or less.

14. The adhesive composite of claim 1, wherein the support layer has a basis weight of greater than about 10 grams per square meter.

15. The adhesive composite of claim 1, wherein the support layer has a basis weight of less than about 65 grams per square meter.

16. The adhesive of claim 1, wherein the repositionable adhesive is a polyacrylate, microsphere-based adhesive.

17. The adhesive of claim 1, wherein the permanent adhesive is an acrylic adhesive.

18. The adhesive composite of claim 3 in the form of a roll of tape, wherein the permanent adhesive is in contact with the second surface of the differential liner.

19. The adhesive composite of claim 3 in the form of a sheet of adhesive, wherein the composite further comprises a second liner disposed on the permanent adhesive.
